(19) United States
(12) Patent Application Publication
(10) Pub. No.: US 2013/0132976 A1
(43) Pub. Date: May 23, 2013

(54) DEADLY EMBRACE

(71) Applicant: KUNG YI LIN, Irvine, CA (US)

(72) Inventor: KUNG YI LIN, Irvine, CA (US)

(21) Appl. No.: 13/298,382

(22) Filed: Nov. 17, 2011

(51) Int. Cl. G06F 9/44

(52) U.S. Cl. 719/318

(57) ABSTRACT

Systems and methods are disclosed that gather database event information that may be used by a debugger to pinpoint problems in applications that lead to inefficiencies in the database. For example, a database system may gather application-specific information from an application execution stack to include in the event log file. The application-specific information provides details as to what portion of the application resulted in the database event. The database event information may then be provided to another application or a user via a user interface.

### TECHNICAL FIELD

The present disclosure relates generally to detecting database events; in particular, the present disclosure relates to detecting and providing information related to deadlock events.

### BACKGROUND

In a database environment, events may occur that cause applications utilizing the database to perform slowly or even hang indefinitely. Often, this is a result of errors in the applications' use of the database, or due to interdependencies among applications using the database. One such example is of applications hanging indefinitely due to errors in the applications is a deadly embrace, otherwise known as a deadlock database event. For example, three applications (A, B, and C) are attempting to utilize a database. Application A is awaiting action (e.g., to perform a task, to provide information, etc.) from Application B before it can finish its database task. Application B is waiting for Application C before it performs the action for Application A. However, Application C is awaiting an action from Application A before it can complete its tasks. In this situation, all three applications are left deadlocked waiting for the other applications to complete their tasks. Furthermore, this deadlock may tie up database resources which may further disrupt performance for other applications.

It is often difficult for an application developer to pinpoint the source of such errors in an application, typically because the errors occur as a result of data interdependency among a number of applications. Existing solutions to this issue involve code developers stepping through application code to arrive at the deadly embrace condition, which requires a great deal of time for the application developer to fix the errors.

For these and other reasons, improvements are desirable.

### SUMMARY

In accordance with the following disclosure, the above and other issues are addressed by the following:

In a first aspect, a method of providing database event information is disclosed. The method includes identifying a database event (e.g., a deadlock event) occurring in a database, the event occurring during execution of one or more applications utilizing the database, and gathering event information associated with each of the one or more applications. The method further includes storing the database event information in a database event file.

In a second aspect, a computer storage medium is disclosed that includes computer-executable instructions, which when executed on a computing device perform a method of providing database event information. That method includes identifying a database event occurring in a database, the event occurring during execution of one or more applications utilizing the database, and in response to identifying the database event, responding to the database event. The method further includes gathering event information, and receiving a subscription request, wherein the subscription request identifies the database event. The method further includes, in response to receiving the subscription request, providing event information.

In a third aspect, a system for providing event information is disclosed. The system includes a database for providing deadlock event information. The database includes a utility configured to identify the deadlock event and gather deadlock event information from an operating system, wherein gathering deadlock event information comprises receiving stack information from the operating system. The utility is further configured to receive a subscription request, wherein the subscription request identifies the database event, and in response to receiving the subscription request, provide event information. The operating system within the system is configured to communicate with the database to providing deadlock event information. The operating system is configured to maintain stack information for one or more applications utilizing the database, wherein the stack information is stored in format compatible with the database. The operating system is further configured to provide the stack information of the one or more applications to the database.

In various embodiments, a database may provide information related to database events. The database may provide a listing of different database events that a subscriber (e.g., a user, an application or program, a database, etc.) can subscribe to. Upon subscribing to the event, the subscriber receives event information from the database directly, through the database operation center that may be a part of the database system, or through an application that is not a part of the database system but is in communication with the system. The database event information may include useful information that can be used to identify the source of database event (e.g., where in the course of the application's execution does the database event occur). In other embodiments, database information may include data related to the database, data related to applications accessing the database, data related to the requests made to the database, or any other type of information related to the database or one or more applications that access the database.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram illustrating an example embodiment of a system for providing database event information;

FIG. 2 is a drawing of an embodiment of a system environment showing a server connected to a disk subsystem;

FIG. 3 is a flow diagram illustrating an embodiment of a method for providing database event information by a database system;

FIG. 4 is a flow diagram illustrating an embodiment of a method for collecting database event information;

FIG. 5 is an illustration of an embodiment of a database event log file;

FIG. 6 is an illustration of an embodiment of a user interface for subscribing to event information;

FIG. 7 is an illustration of an embodiment is yet another embodiment of a user interface for allowing a user to select a specific event;

FIG. 8 is an illustration of an embodiment of a user interface for providing detailed database event information; and

FIG. 9 is a block diagram illustrating example physical details of an electronic computing device, with which aspects of the present disclosure can be implemented.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

Application developers often have difficulty identifying database events that lead to performance issues, such as the deadlock event described above, in their applications. In order to alleviate this problem, it is helpful for the database to provide a debugger that provides information related to database events. For example, a database debugger is provided as a part of a database operations center (“DOC”) that may be used by an application programmer to pinpoint at what point of an application a database event occurs. In embodiments, the database operations center may provide information related to a database event, such as, but not limited to, a deadly embrace or a deadlock event. In such embodiments, the database operation center may provide a listing of different database events that a subscriber (e.g., a user, an application or program, a database, etc.) can subscribe to the event. Upon subscribing to the event, the subscriber receives event information from the database directly or through the database operation center that may be a part of the database system. The database event information may include useful information that can be used to identify the source of database event (e.g., where in the course of the application's execution does the database event occur). In other embodiments, database information may include data related to the database, data related to applications accessing the database, data related to the requests made to the database, or any other type of information related to the database or one or more applications that access the database. Such information may include, but is not limited to, an application identifier, a mix number, and the line number of the application where the database event occurred. In one embodiment, the database event information may be provided in a text file, an XML file, or any other type of file consumable by an application. In another embodiment, the database event information may be provided to the user via a graphical user interface.

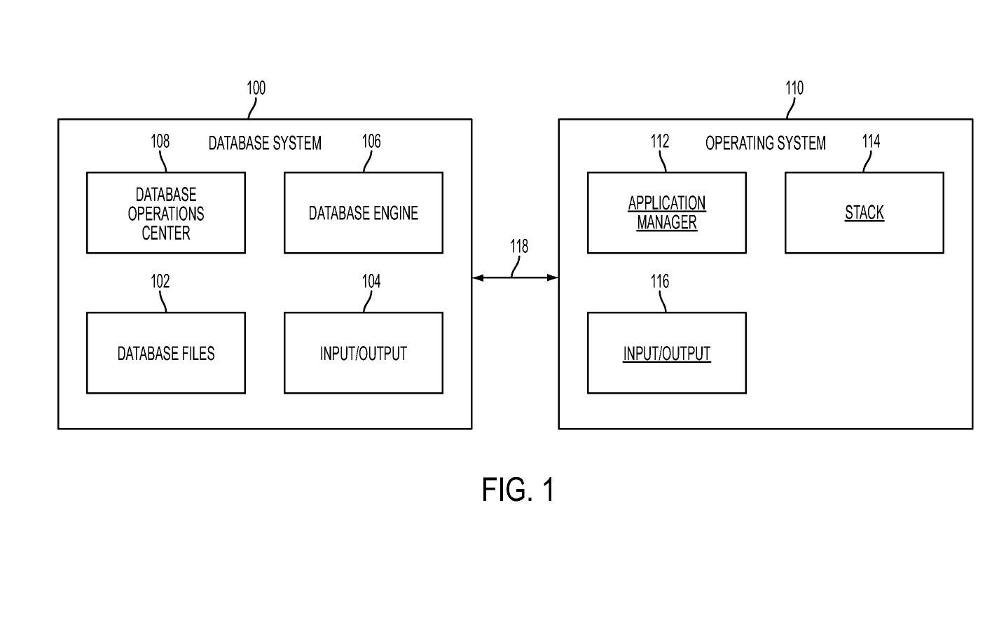

FIG. 1 is a block diagram illustrating an example embodiment of a system for providing database event information. In embodiments, a system for providing database information may a database system 100 and an operating system 110. The database system 100 may include database files 102. The database files 102 may include tables or objects that are normally stored by relational or object databases. The database files 102 make up the database resources that various applications may request access to in order to read or write information. These files may be accessed simultaneously by multiple applications which contend for the database's resources. In some circumstances, the contention may result in a deadlock, which may leave applications hanging indefinitely.

The database system 100 may include a database engine 106. In embodiments, the database engine 106 may perform database related tasks. For example, the database engine 106 may determine which applications are allowed to access database resources. In another embodiment, the database engine 106 may perform tasks related to identifying and handling database events. For example, the database engine 106 may identify deadlock events. In one embodiment, the database engine 106 may handle deadlock events by, for example, terminating the lowest priority application.

In another embodiment, instead of terminating the application itself, the database engine 104 may instruct the operating system 110 to terminate the application via Input/Output component 104. Input/Output component 104 provides the database system 100 with the functionality to communicate with other applications or systems, such as operation system 110. The database system 100 may communicate with other applications or systems via communication medium 118. Communication medium may be a network such as the Internet, a WAN, a LAN, or any other type of network. Communication medium may also be a machine bus or other communication component.

Because the deadlock situations are difficult for application developers to identify, the database system 100 provides database event information that is useful in identifying database event problems. In one embodiment, the database event information may be collected by the database engine 106. For example, if the database event information handles application execution, it may collect information related to the applications that attempt to access database resources, such as database files 102. However, in other embodiments, the database engine does not control the execution of the application and, therefore, must retrieve application information related to database events from another system, such as operating system 110.

For example, operating system 110 may include an application manager 112. The application manager may be used to control the execution of applications by the operating system. In some circumstances, multiple applications may compete for resources on the database system 100. In such situations, the application manager may suspend applications waiting for the database resources and awaken them when the database engine 106 informs the operating system 110 that the resources are free. In other embodiments, the application manager may also terminate applications when a deadlock is detected. The deadlock may be detected by the database engine 106 or the operating system 110.

The operating system also includes a stack 114. The stack stores information related to the execution of one or more applications on the operating system. Generally, stack information is stored as machine code. Furthermore, operating systems do not store the entire stack history of applications. In order to provide useful debugging information, the stack 114 is modified to store debugging information. Such information may include, but is not limited to, an application identifier (e.g., an ID number or the application name), the sequence number (or line number) of the application, a mix number, or any other type of information that will aid a developer in debugging a database event. Furthermore, the stack 114 stores the application information in a way that is readable to a human or another application. For example, the stack 114 may store the information as text, as XML, as HTML, or in any other type of readable format.

The application information stored in the stack 114 is returned to the database via the operating systems Input/Output component 116 using communication medium 116. The stack information may be gathered by the database engine 106 and stored in an event log file as database event information. For example, if a deadlock occurs between two or more applications, the stack information of the two or more applications is retrieved from the operating system 110 and stored in the database system 100. The stack information becomes part of the database event information that can be used in debugging the one or more applications in order to pinpoint and fix the cause of the deadlock within the applications. Database may include a database operation center 108 that provides a developer with access to the database event information that includes the stack information. For example, the database control center 108 may provide a user interface that a developer can use to subscribe to information related to an event. While subscribed to the event information, the user can access the database event information and the one or more application stack information in order to pinpoint the cause of the database event within the one or more applications. Including the stack information is helpful because it provides the line number that the one or more applications were executing when the deadlock occurs. This allows the developer to quickly locate the cause of a database event, such as a deadlock, within the application and greatly simplifies an otherwise complex debugging task.

In yet another embodiment, rather than providing the database event information via a user interface, the database system 100 may allow other applications to consume the database event information. For example, a debugger may access the database event information gathered and stored in the database system 100 in order to pinpoint the cause of the database event.

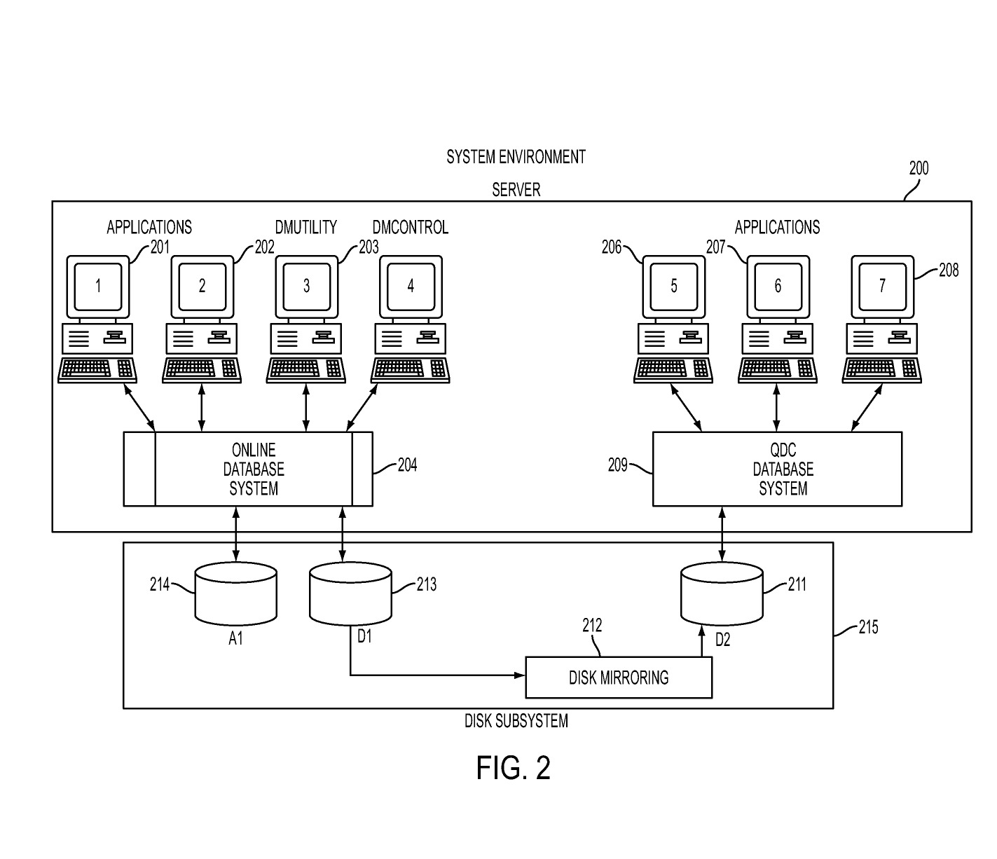

FIG. 2 is an illustration of an embodiment of a system environment. The server 200 is used to run several different applications and utilizes the personal computer client-users 201, 202, and 203, which interact with and access the database system 204 within the server 200. Users, in this context, can include administrative users managing database structure and permissions, as well as applications which interact with the database. The server also utilizes the PC client-users 206, 207 and 208, which interact with and access the database system 209 (shown in this embodiment as QDC database system) within the single server 200.

Within the disk subsystem 215, the data files contained in the disk 213 (D1) are communicated back and forth with the primary online database system 204, and also optionally sent via the disk mirroring system 212 to disk (D2), 211. Disk (D2) 211, contains the mirrored database snapshot.

The data files of database system 204 are mirrored via system 212 and communicated to the secondary database system 209.

Although in this example system environment the server contains two separate database systems 204, 209, it is recognized that in the context of the present disclosure, only one database system may be present. Additionally, mirroring among disks 211, 213 may or may not occur in certain embodiments.

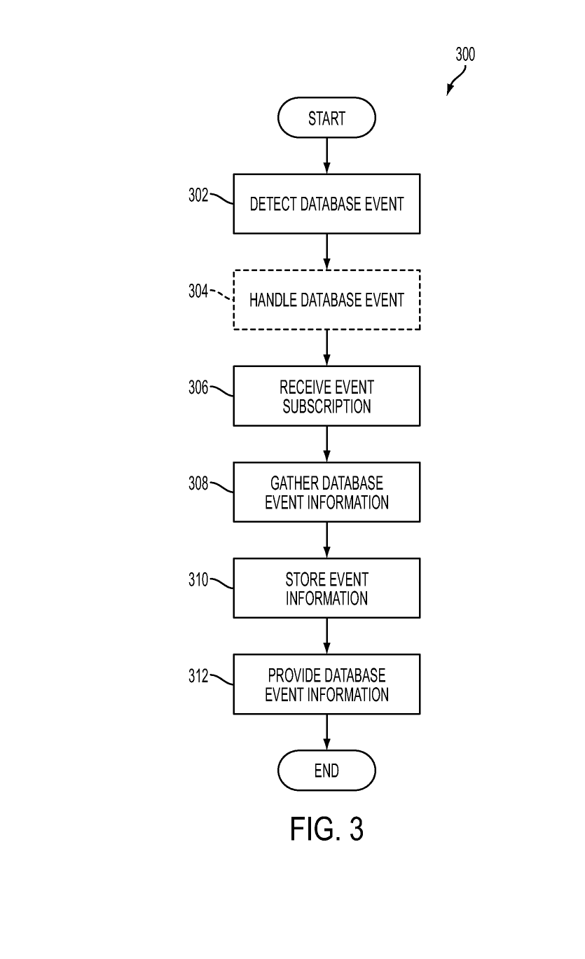

FIG. 3 is a flow diagram illustrating an embodiment of a method 300 for providing database event information by a database system. In embodiments, the method 300 may be performed by a database, such as database system 100 (FIG. 1). In further embodiments, the method 300 may be performed by a particular component of the database system, such as a database engine 106 (FIG. 1). In yet another embodiment, the method 300 may be performed by an operating system that is not a part of the database system, such as an operating system 110 (FIG. 1). One of skill in the art will appreciate that the method 300 may be performed by any machine or software component that is part of a database system or in communication with a database system.

Flow begins at operation 302, where the method 300 detects a database event. A database event can be any type of event that occurs in the database system. In another embodiment, a database event may be a deadlock event. Upon detecting the event, flow continues to optional operation 304. At optional operation 304, method 300 may handle the database event. For example, if the database event is a deadlock event, the method 300 may terminate one or more of the applications causing the deadlock at operation 304. In another embodiment, rather than handling the database event itself, the method 300 may instruct another component to handle the database event at operation 304. For example, if the method 300 is performed by a database system or a database engine, the database system may instruct an operating system to terminate one or more applications at operation 304.

One of skill in the art will recognize that it is not necessary for the method to handle the database event in order to provide information about the database event. Indeed, in some situations it may be desirable to gather database event information prior to handling the event in order to determine how to handle the database event. For these reasons, operation 304 is an optional operation.

Flow continues to operation 306 where the method 300 receives a subscription to a database event. In embodiments, a subscription to the database event is an indication that a user or another application wants to track or access the database event information. For example, a user may access the database event information through a user interface provided by a database operations center. In such embodiments, the user may subscribe to the event by selecting the event from a user interface. In another embodiment, an application may subscribe to the database event information by sending a request message to the system or application performing the method 300.

Flow continues to operation 308 where the method 300 gathers the subscribed-to database event information. In one embodiment, database event information may be stored locally on a device performing operation 300. For example, in one embodiment, gathering database information may consist of accessing local data. Local data may reside in a local file or data structure such as, but not limited to, an event log file, a system stack, etc.

In another embodiment, gathering database event information may comprise requesting the database event information from another source. For example, when a database engine detects a deadlock, it may instruct an operating system to terminate the lowest priority application that is part of the deadlock. In embodiments, the operating system, not the database engine, manages the execution of the application. Therefore, it is necessary for the operating system to terminate the application.

Generally, operating systems maintain a stack that stores application data. However, the information generally stored in an operating system stack is limited. For example, not all of the application execution information or all of the data related to the application is stored in the operating system stack. Furthermore, the stack information is generally stored as machine code, which is unreadable to humans. Therefore, in order to provide useful debugging information, the operating systems stack is modified such that the operating system stores debugging information in the stack. Such information may include, but is not limited to, an application identifier (e.g., an ID number or the application name), the sequence number (or line number) of the application, a mix number, or any other type of information that will aid a developer in debugging a database event. Furthermore, the stack is modified to store the application information in a way that is readable to a human or another application. For example, the stack may store the information as text, as XML, as HTML, or in any other type of readable format. By making such modifications to the operating system stack, the stack information is placed in a form that is consumable by a database system or database engine. Such stack information may be retrieved from the operating system at operation 306 and provided to another application or system, such as a database system.

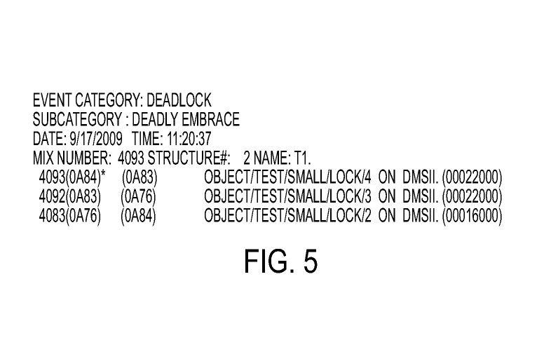

After gathering the database event information at operation 308, flow continues to operation 310 where the database event information is stored. For example, if the database event information was retrieved from a modified operating system stack as described with respect to operation 308, the database information may be stored locally. For example, the database event information may be stored in a database event log file. The database event information may be stored in a human readable or application consumable format. For example, the database event may be stored in an event log file in a text, an XML format, an HTML format, or any other type of human readable or application consumable format. For example, FIG. 5 provides an example embodiment of a database event log file storing database event information related to a deadlock.

Furthermore, multiple database events may be stored. In such embodiments, the multiple events may be stored in multiple event files. In yet another embodiment, multiple database events may be stored in a single file (e.g., one event log file). In such embodiments, the single file may contain multiple XML streams, where each stream relates to a different database event. Storing the database event information allows a developer or application to access the database event information at a later time.

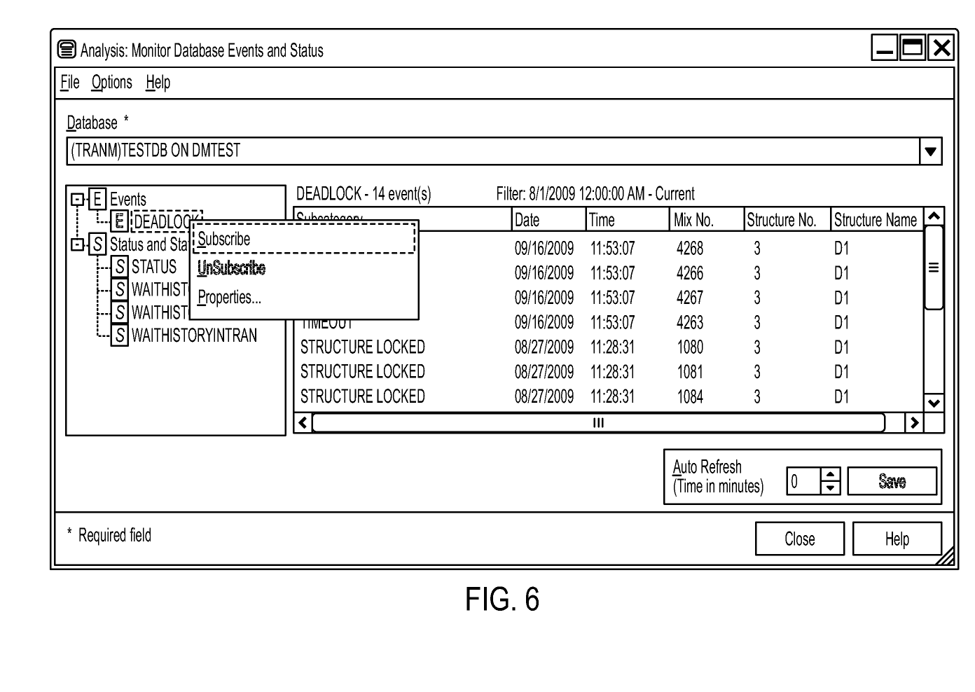

Upon receiving and storing the database event information defined by the event subscription, flow continues to operation 312 where the database event information is provided to a subscriber. In one embodiment, providing the database event information comprises sending the database event information to another application. In doing so, the database event information may be converted into a specific format for consumption by the application. In another embodiment, providing the database event information may comprise displaying the event information to a user via a user interface. For example, a user may request event information using a database operations center. In such embodiments, providing the database event information may comprise displaying the database event information to the user via the database operations center's user interface. Example embodiments of the user interface are provided in FIGS. 6-8.

As shown above, the method 300 provides database event information to developers or other applications. In embodiments, such data includes a mix number, an application identifier, the application line number at which the database event occurred, or any other relevant information. Such information can aid a debugger or an application developer in locating problems within an application that inefficiently use the database system, thereby helping the application developer located portions of the application code to fix in order to avoid database problems, such as deadlocks.

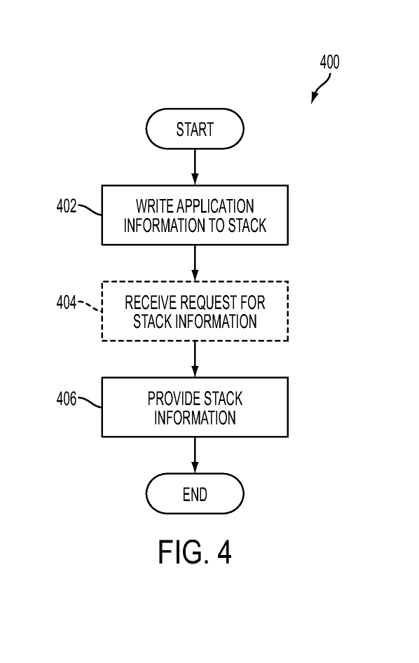

FIG. 4 is a flow diagram illustrating an embodiment of a method for collecting database event information. In embodiments, the method 400 may be performed by a database system or a database engine. In another embodiment, the method 400 is performed by an operating system. Generally, the operating system controls the execution of applications. When applications access a database, they compete for the database's resources. The operating system may control the competition by suspending applications when database resources are unavailable and then awakening them when the resources become available. Because these actions are managed by the operating system, collecting database event information (e.g., information related to applications attempting to access database resources) may be most efficiently handled by the operating system.

Flow begins at operation 402 where application information is written to the stack. As discussed with respect to FIG. 3, the stack may be modified to store application information that is readable by humans or consumable by other applications. In further embodiments, all information related to applications accessing or attempting to access a database resource is written to the stack. Such information may include the execution history of the application (e.g., the number of times the application was suspended and awakened while attempting to access the database resource), application specific data (e.g., the application ID, the current line number of the application during execution, etc.) or any other type of relevant information. In embodiments, debugging information is also written to the stack at operation 402. In embodiments, database event information may comprise any of the information written to the stack at operation 402.

Flow continues to optional operation 402, where the device or system performing the method 400 receives a request for the stack information. For example, a database system may request the operating system provides its stack information for analysis. In another embodiment, a user or application may subscribe to the stack information at operation 402 in a manner similar to the subscriptions discussed in FIG. 3. Operation 402 is optional because, in embodiments, the stack information may be provided to a user, another application, or another system automatically upon collection. However, in some embodiments, it may not be efficient to always provide stack information. In such embodiments, the stack information may only be provided upon receiving a request at operation 402. At operation 406, the stack information is provided. For example, the stack information may be provided to a database for storage in an event log file. In another embodiment, the stack information may be provided to another application or to a user via a user interface.

FIG. 5 is an illustration of an embodiment of a database event log file of the present disclosure. As illustrated in FIG. 5, the database event log 500 includes application stack information that may be collected from an operating system. For example, the database event log file is modified to include application information related to the database event as discussed with respect to FIGS. 1, 3, and 4. The database event log 500 includes an event identifier 502 that indicates that a deadlock has occurred. The event log 500 also includes a subcategory identifier 502 that indicates that the deadlock is a deadly embrace. In embodiments, the event log will also include information related to the one or more applications involved in the database event. For example, in the embodiment illustrated in FIG. 5, 3 applications are involved in a deadly embrace. The event log includes information related to the three applications. In the embodiment illustrated in FIG. 5, the application related data includes mix number 506, structure numbers 508, application identifiers 510, and the line numbers 512 that application was executing when the deadly embrace occurred. While the embodiment illustrated in FIG. 5 provides specific information related to a specific database event, one of skill in the art will appreciate that information related to other types of database events may be included in the event log. Furthermore, more or less application specific information may be included than what is illustrated in the embodiment presented in FIG. 5.

FIG. 6 is an illustration of an embodiment of a user interface for subscribing to event information. For example, the user interface 600 may be a part of the database system. In another embodiment, the user interface may be provided by a database control center. In further embodiments, the user interface 600 may be provided by another application unrelated to the database system. The embodiment of the user interface 600 includes a listing of different database events in the left window. For example, the listing of events may be grouped by event types, such as “DEADLOCK” events 602. A user may select an event type to display more information about the types of events. As illustrated in the embodiment of FIG. 6, a user may select the event type by clicking on the event 602 and selecting to subscribe to the event via a context menu 604. Although not shown in FIG. 6, the user may also subscribe to the event using a drop down menu. The user may also request additional information about the event by selecting “Properties” from the context menu 604.

In embodiments, upon selecting an event type, such as a “DEADLOCK,” all of the deadlock events may be presented in the right pane of the user interface 600. Information related to the database event, such as, but not limited to, the time of the event, the date of the event, the mix number, the application ID's, etc. may also be displayed in the right pane.

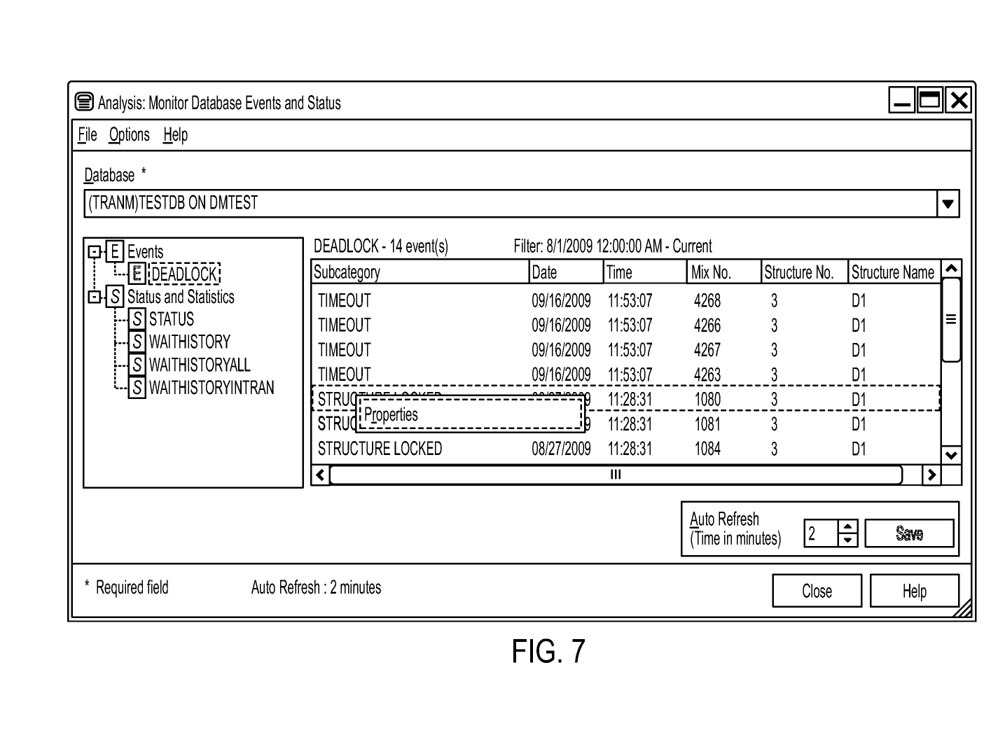

FIG. 7 is an illustration of an embodiment is yet another embodiment of a user interface for allowing a user to select a specific event. As illustrated in user interface 700, a user can select detailed information from a particular event, in this case, a deadlock event, by clicking on the specific event to bring up a context menu 702. The user can select “Properties” from the context menu in order to get more detailed information related to the particular database event. In another embodiment, the user may use a drop down menu or simply click on the event in order to select a more detailed view of the event.

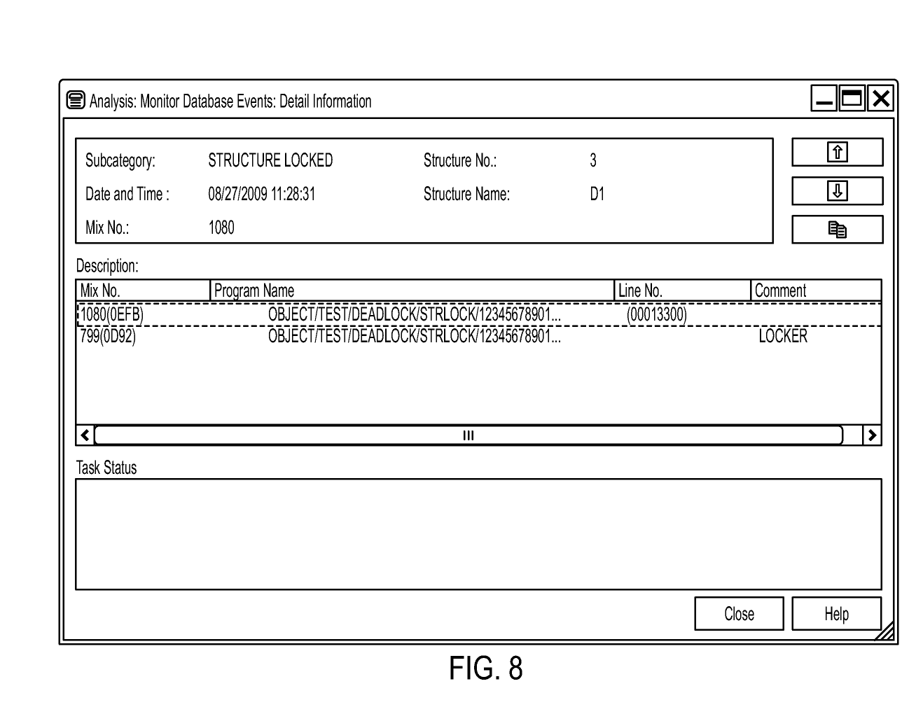

FIG. 8 is an illustration of an embodiment of a user interface for providing detailed database event information. For example, the user interface 800 may be presented upon a user selecting a specific database event, as described with respect to FIG. 7. As shown in user interface 800, detailed database event information may be provided to the user. The database event information may include information related to applications that are involved in the database event. For example, such information can include, but is not limited to, mix number 802, application identifier 804, and application line number 806. By providing this information, an application developer can quickly and easily identify any problems in the application and provide a fix to the application in order to avoid the database event in the future.

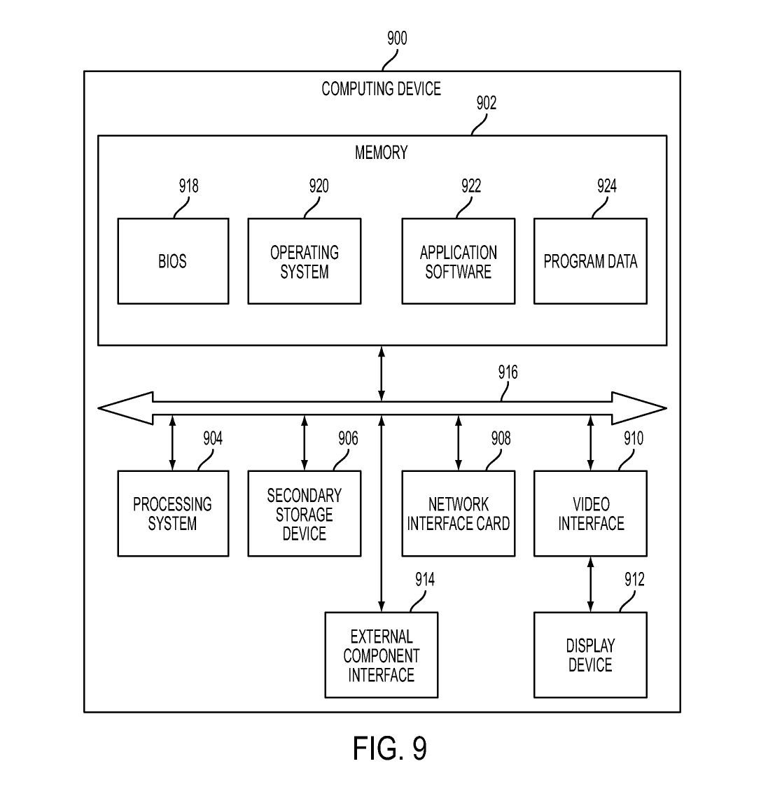

FIG. 9 is a block diagram illustrating an example computing device 900. In some embodiments, the database system 100 and/or a device with the operating system 110 are implemented as one or more computing devices like the computing device 900. It should be appreciated that in other embodiments, the database system 100 and/or a device with the operating system 110 are implemented using computing devices having hardware components other than those illustrated in the example of FIG. 9.

The term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

In the example of FIG. 9, the computing device 900 includes a memory 902, a processing system 904, a secondary storage device 906, a network interface card 908, a video interface 910, a display unit 912, an external component interface 914, and a communication medium 916. The memory 902 includes one or more computer storage media capable of storing data and/or instructions. In different embodiments, the memory 902 is implemented in different ways. For example, the memory 902 can be implemented using various types of computer storage media.

The processing system 904 includes one or more processing units. A processing unit is a physical device or article of manufacture comprising one or more integrated circuits that selectively execute software instructions. In various embodiments, the processing system 904 is implemented in various ways. For example, the processing system 904 can be implemented as one or more processing cores. In another example, the processing system 904 can include one or more separate microprocessors. In yet another example embodiment, the processing system 904 can include an application-specific integrated circuit (ASIC) that provides specific functionality. In yet another example, the processing system 904 provides specific functionality by using an ASIC and by executing computer-executable instructions.

The secondary storage device 906 includes one or more computer storage media. The secondary storage device 906 stores data and software instructions not directly accessible by the processing system 904. In other words, the processing system 904 performs an I/O operation to retrieve data and/or software instructions from the secondary storage device 906. In various embodiments, the secondary storage device 906 includes various types of computer storage media. For example, the secondary storage device 906 can include one or more magnetic disks, magnetic tape drives, optical discs, solid state memory devices, and/or other types of computer storage media.

The network interface card 908 enables the computing device 900 to send data to and receive data from a communication network. In different embodiments, the network interface card 908 is implemented in different ways. For example, the network interface card 908 can be implemented as an Ethernet interface, a token-ring network interface, a fiber optic network interface, a wireless network interface (e.g., WiFi, WiMax, etc.), or another type of network interface.

The video interface 910 enables the computing device 900 to output video information to the display unit 912. The display unit 912 can be various types of devices for displaying video information, such as a cathode-ray tube display, an LCD display panel, a plasma screen display panel, a touch-sensitive display panel, an LED screen, or a projector. The video interface 910 can communicate with the display unit 912 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 914 enables the computing device 900 to communicate with external devices. For example, the external component interface 914 can be a USB interface, a FireWire interface, a serial port interface, a parallel port interface, a PS/2 interface, and/or another type of interface that enables the computing device 900 to communicate with external devices. In various embodiments, the external component interface 914 enables the computing device 900 to communicate with various external components, such as external storage devices, input devices, speakers, modems, media player docks, other computing devices, scanners, digital cameras, and fingerprint readers.

The communications medium 916 facilitates communication among the hardware components of the computing device 900. In the example of FIG. 9, the communications medium 916 facilitates communication among the memory 902, the processing system 904, the secondary storage device 906, the network interface card 908, the video interface 910, and the external component interface 914. The communications medium 916 can be implemented in various ways. For example, the communications medium 916 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 902 stores various types of data and/or software instructions. For instance, in the example of FIG. 9, the memory 902 stores a Basic Input/Output System (BIOS) 918 and an operating system 920. The BIOS 918 includes a set of computer-executable instructions that, when executed by the processing system 904, cause the computing device 900 to boot up. The operating system 920 includes a set of computer-executable instructions that, when executed by the processing system 904, cause the computing device 900 to provide an operating system that coordinates the activities and sharing of resources of the computing device 900. Furthermore, the memory 902 stores application software 922. The application software 922 includes computer-executable instructions, that when executed by the processing system 904, cause the computing device 900 to provide one or more applications. The memory 902 also stores program data 924. The program data 924 is data used by programs that execute on the computing device 900.

Overall, a number of advantages of the methods and systems of the present disclosure exist and are described throughout the disclosure. For example, the deadly embrace reporting arrangements provided herein provide an enhanced method of visualizing and detecting deadly embrace conditions, thereby greatly reducing the time required to debug such conditions. Additionally, advantages exist that may not have been explicitly described herein.

The various embodiments described above are provided by way of illustration only and should not be construed as limiting. Those skilled in the art will readily recognize various modifications and changes that may be made without following the example embodiments and applications illustrated and described herein. For example, the operations shown in the figures are merely examples. In various embodiments, similar operations can include more or fewer steps than those shown in the figures. Furthermore, in other embodiments, similar operations can include the steps of the operations shown in the figures in different orders. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of providing database event information, the method comprising:
identifying a database event occurring in a database, the event occurring during execution of one or more applications utilizing the database;
gathering event information associated with each of the one or more applications; and
storing the database event information in a database event file.

2. The method of claim 1, wherein the database event is a deadlock event occurring among the one or more applications.

3. The method of claim 1, further comprising:
receiving a subscription request, wherein the subscription request identifies the database event; and
in response to receiving the subscription request, providing event information.

4. The method of claim 3, wherein gathering the event information comprises receiving the event information from an operating system.

5. The method of claim 4, wherein the event information is collected by an operating system executing on a computing system hosting the database and includes stack information associated with the one or more applications.

6. The method of claim 3, wherein providing the event information comprises displaying the event information in a user interface.

7. The method of claim 1, wherein the event information comprises a mix number, an application name, and a line number.

8. The method of claim 1, wherein the database event file comprises at least one XML stream.

9. The method of claim 1, further comprising, in response to identifying the database event, responding to the database event.

10. The method of claim 9, wherein the database event is a deadlock event occurring among the one or more applications, and wherein responding to the database event corresponds to terminating a lowest-priority application from among the one or more applications.

11. A computer storage medium comprising computer-executable instructions, which when executed on a computing device perform a method of providing database event information, the method comprising:
identifying a database event occurring in a database, the event occurring during execution of one or more applications utilizing the database;
in response to identifying the database event, responding to the database event;
receiving a subscription request, wherein the subscription request identifies the database event;
gathering event information; and
in response to receiving the subscription request, providing event information.

12. The computer storage medium of claim 11, wherein the database event is a deadlock event.

13. The computer storage medium of claim 12, wherein responding to the database event comprises terminating a first application that is a part of the deadlock event, wherein the first application has a lowest priority.

14. The computer storage medium of claim 11, wherein providing the event information comprises displaying the event information in a user interface.

15. The computer storage medium of claim 14, wherein displaying the event information comprises displaying a mix number, an application name, and a line number of the application.

16. The computer storage medium of claim 11, wherein gathering the event information comprises receiving stack information from an operating system, wherein the stack information is related to the database event.

17. A system for providing event information, the system comprising:
a database including a utility configured to provide deadlock event information, wherein the utility is configured to:
identify the deadlock event;
receive a subscription request, wherein the subscription request identifies the deadlock event;
gather deadlock event information from an operating system, wherein gathering deadlock event information comprises receiving stack information from the operating system; and
in response to receiving the subscription request, provide event information; and
the operating system communicating with the database for providing deadlock event information, wherein the operating system is configured to:
maintain stack information for one or more applications utilizing the database, wherein the stack information is stored in format compatible with the database; and
provide the stack information of the one or more applications to the database.

18. The system of claim 17, wherein the stack information comprises a mix number, an application name, and a line number.

19. The system of claim 17, wherein the stack information is stored in an XML format.

20. The system of claim 17, wherein the operating system maintains an entire stack history for the one or more applications utilizing the database.
